(19) United States
(12) Patent Application Publication
(10) Pub. No.: US 2001/0036322 A1
(43) Pub. Date: Nov. 1, 2001

(54) Image processing system using an array processor

(76) Inventors: John F. Bloomfield, South Hampton, NH (US); Shepard L. Siegel, Auburn, NH (US)

Correspondence Address: WEINGARTEN, SCHURGIN, GAGNEBIN, & HAYES, LLP, TEN POST OFFICE SQUARE, BOSTON, MA, 02109, US

(21) Appl. No.: 09/803,379

(22) Filed: Mar. 9, 2001

Related U.S. Application Data
(60) Provisional application No. 60/188,377, filed on Mar. 10, 2000.

(51) Int. Cl. G06K 9/36

(52) U.S. Cl. 382/276; 382/305

(57) ABSTRACT

A modular image processing system comprises a sensor interface, an image capture and processing subsystem, software to adapt the components to a task and a host computer to monitor and control the process as well as process data. The sensor interface is co-located with cameras or other sensors focused on a target. It encodes the image data and transmits it serially to the image capture and processing subsystem. The subsystem reformats the received image data and stores it in an image memory. The subsystem also passes on the serial data for use by other instances of the subsystem. The subsystem processes the data according to programmed algorithms and passes the results to the host computer. The host processor collaborates with embedded processors within the subsystem to programmably configure the sensor interface, the serial data format and the algorithms executed by the image capture and processing subsystem.

### CROSS REFERENCE TO RELATED APPLICATIONS

This patent application claims priority under 35 U.S.C. §119(e) to provisional patent application serial No. 60/188,377 filed Mar. 10, 2000; the disclosure of which is incorporated herein by reference.

### STATEMENT REGARDING FEDERALLY SPONSORED RESEARCH OR DEVELOPMENT

N/A

### BACKGROUND OF THE INVENTION

The present invention relates generally to digital image processing.

The demands of real-time image processing applications have always required extensive computational resources. The enormous volume of data that frame-rate applications must handle, and the short time available in which to process it, have led to a variety of solutions to cope with the challenges.

Typically, a camera formed the image that was then recorded by a frame grabber. The frame grabber produced a digital image in a memory. A processing machine performed further processing of the digital image.

Single instruction multiple data (SIMD) machines offer a generalized processor approach that breaks up the data and passes it to multiple processors. One topology that has frequently appeared is a linear array of general purpose PROCESSORs. In a SIMD machine, each processor performs the same instruction in lockstep on different data. These processors generally provide no specialized computational leverage.

The SIMD approach has numerous drawbacks. It tends to suffer from I/O bottlenecks associated with getting data sets into and out of the processors. More importantly, because a single processor module cannot offer sufficient horsepower to process even a moderate size image array, much larger board sets are required with the increased complexities that result. When large array images are “strip-mined” or cut into sections and handled by different processors the strip edges are not handled. The results must be subsequently knit together, performing analysis at the boundaries that must be dealt with before further analysis can proceed. Therefore a system, beyond the SIMD machines, must be associated with the SIMD set up to perform the coordination.

For additional flexibility, the multiple instruction multiple data (MIMD) architecture was developed. These machines are typically formed from processor “nodes” that are interconnected in some topology (often as a grid), in which data can be passed from node to node via the interconnect fabric. Usually each node is attached to both local memory and some shared memory and executes potentially separate instructions on data that is fed to it. The MIMD array of processors presents a more complex operational paradigm than the SIMD approach, as multiple data sets and instructions operate independently yet require synchronization. Partitioning of the problem for computational efficiency is important and complex in a MIMD machine. Homogeneous computational elements reduce the complexity of applications development, but performance is traded off to keep the application development conceptually manageable. This approach requires a large degree of data control, with 30% to 40% of instructions aimed at organizing the program and moving data between nodes, rather than processing the data itself.

The complexity of managing the MIMD topology in real time without a sufficiently broad control paradigm minimizes its use in real-time imaging applications except in a singular application, such as a tracking engine. Even in such an application, pipeline processors are used for “front end” data reduction (such as adaptive filtering), and the reduced data is passed to the MIMD device to execute the “tracking” portion of the application. MIMD machines have been made that consist of an array of i860s, and specialized software libraries have been hand-tuned to yield theoretical performance metrics in the hundreds of MFLOPS. Similar products have been integrated successfully into various imaging applications. A MIMD device can accelerate floating point functions or perform more generalized processing tasks, such as analysis using neural net methodologies. In the MIMD architecture, much of the bottleneck is created in getting the right data to the right processor.

Pipeline processing can be thought of as a special case of the MIMD paradigm, where each node in the grid is a specialized processing element and complex parallel processing data paths can be reconfigured. For example, a multiplier element in a pipeline processing system does not use any local memory to store intermediate results, but is instead a “brute-force” hardware element that performs only multiplication. This is quite different from a generic PROCESSOR that executes microcode, fetches operands from memory, performs an operation, and then saves the results back to memory.

Individual specialized processing elements are explicitly embedded at the correct location in the data flow, and no system resources are required to distribute the data. Thus data pipelines, once set up, are virtually maintenance free, continuing to process image data without any further contact with the host PROCESSOR. A detriment to pipeline processing is that the topology and synchronization of the pipeline are crucial.

The inherent power of pipeline architecture is that the data is processed at the most efficient location possible in the pipeline, and this “assembly-line” processing arrangement guarantees continuous data flow in the shortest possible increments. Pipeline processing offers performance improvements orders-of-magnitude better than processor-based approaches and, for certain applications, can outperform supercomputers costing far more. A detriment to pipeline processing is the necessity to reconfigure the fixed processing resources to match the needs of a particular application. A series of high bandwidth crosspoint switches are needed for the independent routing of data paths between separate processing devices. This allows for a modular approach to image processing and keeps more processing resources on the same board set, but each processing device requires additional multiplexors and crosspoints to allow data to be sent through a wide variety of paths.

The pipeline processor can function as a highly flexible computational architecture, well suited to image processing operations on integer-based 2D data sets requiring high throughput. However, a sophisticated library of control software functions is needed to construct these topologies and set the programmable attributes of the processing elements. Because each pipeline processor may be unique, a new library entry will be needed for each pipeline element. The need for this library limits the applicability of the pipeline architecture.

In prior image processing systems, different target applications have been regarded as requiring special capabilities. Today many applications are converging to require high-speed, high data-rate handling of massive quantities of data. Current image processing requirements preclude the use of prior solution hardware and software. Image arrays can exceed 8K by 8K pixels and frame rates can exceed hundreds of frames per second. As the demand for higher resolution increases, pixel depths of 8 bits are giving way to pixel depths of 12 bits or 16 bits while the growing need for color processing is pushing pixel depths to 24 bits. Working with such data provides major challenges not adequately met by prior image processing systems.

### BRIEF SUMMARY OF THE INVENTION

The disclosed image processing system utilizes configurable resources to accommodate a variety of sizes of images and data-rates with configurations built from the same physical hardware. Where an image parameter exceeds the capabilities of one instance of a hardware component, parallel resources are configured to accommodate the processing load.

The system includes a data input section, a data storage section, a data processing section with an intermediate storage capability, a results output section and modular control software to set-up and coordinate the outputs of the other sections. The system incorporates one or more processors that provide traditional access to the image data for the analysis best performed by traditional computers, display and archival storage. Physically the components of the system may be distributed in various mounting enclosures including ones close to the cameras, in computer cabinets, and in specialized enclosures.

More particularly, the system is composed of image sensor interface components with flexible connection capabilities. The input interface components are placed close to the image sensors enabling the interface to be easily customized and reducing noise pickup. The conditioned input sensors connect to data acquisition board(s). The acquisition board preprocesses the sensor input and adjusts for skew and displacement before presenting the data for storage in an image memory. The input preprocessor also provides a loopback for the sensor input so it can be passed along to other processors arranged in a daisy-chained fashion.

Regardless of the configuration of sensor inputs, all data is stored in image memory as if one sensor were providing the data. When multiple processors are needed to accommodate the data rate, the overall image may be broken into tiles or stripes that are fed to separate acquisition sections. Any tiles or stripes are formatted to minimize processing difficulties with edge effects.

A memory controller packs data into the proper width for the image memory, controls addressing, and brokers access to the image memory. Contenders for access to memory include the sensor data through the acquisition section, an on-board processor, the host processor and data ports feeding data to the image processor board(s). The image memory holds all data in wide words that are provided to these components. The data is provided to the processing array from the image memory in the logical format needed for processing.

Except for instances when data is to be gathered and merely displayed by the host computer, processor boards are utilized to analyze the data placed in the image memory. The processor boards incorporate an array of multifunctional, programmable pipeline processors to analyze the data. These processors include arithmetic sections, a memory section, a byte crosspoint, a data bit crosspoint, and a cell to cell interconnect. A sequence of commands to configure the interconnection of the elements in the array processors is downloaded from the host computer. In one typical application, the processors are used to find defects in a device being imaged. The processor boards include a processing image memory to hold models for comparison, to hold intermediate results for further processing and to hold final analysis results.

The system can accommodate acquisition and processing throughput in modular increments of several hundred MBytes/second, and can be scaled to support multi-Gbyte/second throughput with multi-TeraOperations/second of processing power. Each acquisition or processing component includes a high performance processor for embedded control to enable standalone and real-time applications. The acquisition logic formats data from the input/sensor or array of sensors as a coherent image in the image memory. The processing array utilizes configurable processing elements to apply data flow technology to analyze the data in image memory.

Modular pipeline processing and storage resources are part of the processing array. Up to two processing arrays may be connected to receive data from one image memory to accommodate higher processing loads. The acquisition logic and processing array are organized onto two option boards that mount in open-standard systems containing commercially available processors.

The system has extensive programmable features and employs a software framework to set up and control the hardware. The software for the image processing system includes a hierarchical imaging and control library, a resource manager, a processing concatenation module and an event and data flow manager. With these components, a combination of processing steps can be linked to act on data in a set of boards sufficient to handle the data bandwidth. The system has the advantages of scalability, ease of programming, deterministic high-speed processing, high throughput, controllability, and extensibility.

### BRIEF DESCRIPTION OF THE SEVERAL VIEWS OF THE DRAWING

These and other objects, aspects and advantages of the present invention will become clear as the invention becomes better understood by referring to the following solely exemplary and non-limiting detailed description of the method thereof and to the drawings, in which:

FIG. 1 is a block diagram of a prior art imaging configuration;

FIG. 2 is a functional block diagram of an image processing system in accordance with the present invention;

FIG. 3 is a block diagram of a sensor interface subsystem in the image processing system of FIG. 2;

FIG. 4 is a block diagram of a data acquisition subsystem in the image processing system of FIG. 2;

FIG. 5 is a block diagram of a data interface subsystem in the data acquisition system of FIG. 4;

FIG. 6 is a block diagram of the data formatting subsystem in the data acquisition system of FIG. 4;

FIG. 7 is a block diagram of the acquisition image memory controller in the data acquisition system of FIG. 4;

FIG. 8a is a block diagram of the processor board and processor image memory in the image processing system of FIG. 2;

FIG. 8b is a block diagram of the processor image memory controller in the processor board of FIG. 8a;

FIG. 9 is a block diagram of the processing array and associated memories in the processor board of FIG. 8a;

FIG. 10 is a floor plan view of the array of cells in the processor board of FIG. 8a;

FIG. 11a is a functional block diagram of the array of cells shown in FIG. 10;

FIG. 11b is a block diagram of one cell in the array of cells of FIG. 10 emphasizing the interconnects;

FIG. 12a-12e are illustrations of configurations of interconnected acquisition and processing boards of the image processing system of FIG. 2;

FIG. 13 is a diagram illustrating a configuration of resources to create a subswath of image memory using the data acquisition subsystem of FIG. 4;

FIG. 14 is a flow chart of an initialization process of the image processing system of FIG. 2 as conducted by software control;

FIG. 15 is a representation of a larger scale image processing system of FIG. 2 implemented in multiple computer systems;

FIG. 16 is a diagram illustrating the mapping of a processing task to one acquisition and processing board set of the image processing system of FIG. 2; and

FIG. 17 is a diagram illustrating the mapping of a processing task onto a number of board sets of the image processing system of FIG. 2.

### DETAILED DESCRIPTION OF THE INVENTION

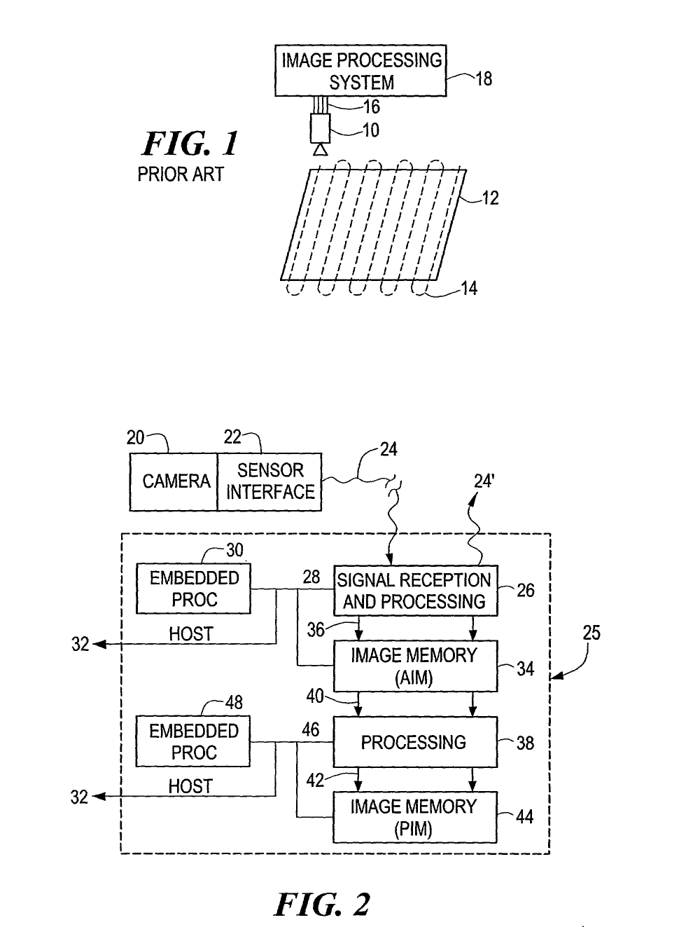

The typical prior art process of scanning an image, for example to find defects, is illustrated in FIG. 1. A camera 10 is focused on a target 12. Camera 10 may have one or multiple taps 16. For a single tap, each scanned line of the image is sequentially transmitted through the tap. For multiple taps 16, each tap scans a different portion of the image so that the different tap outputs must be juxtaposed to reconstruct the image before further processing. Because of the number of taps available from cameras and the high frequency of the incoming data, most imaging systems are placed close to the cameras to limit noise and latency. When the target 12 is inspected with high resolution such that the camera 10 cannot adequately resolve the target 12 in one sweep, a mechanism (not shown) moves the camera 10 and target 12 relative to each other so that the camera 10 traces a path that covers the entire target 12. Illustrated path 14 is one such path to scan the target 12. As the path 14 is traced, the image is captured and placed in the imaging system 18. If a defect is entirely contained within one segment of the path 14, the processing is relatively simple. However, if a defect spans two segments of the path 14, or two taps of the camera, it is a more significant problem to splice the images together before the defect detection can be accomplished. Therefore, as the data from the camera 10 is placed in the imaging system 18, it must be formatted to create the correct image. This formatting may include removing skew, aligning the adjacent pixels, cropping the incoming data and synchronizing the edges of the target.

Image data comes into an imaging system on pathways that typically have no memory, such as a camera output. Therefore, the processing must be completed in real-time so data is not lost. For some of the processing, this requires temporary storage as words of the correct length and format are constructed. Once the image is constructed in the imaging system, it needs to be processed to find the defect. Such processing may take many forms, but generally includes comparing two images which must to be aligned before any comparison can be done. It has been found that the processing of video images is most advantageously done by pipeline processors as previously described.

Image processing systems are typically custom configured to solve one particular problem. For instance, imaging processing system 18, sized to receive and process an image of the target 12, might be located adjacent to camera 10 and be configured for one defect detection method. The system 18 may not be adaptable to other inspection tasks without extensive modification.

A block diagram of a modular image processing and data interface system is shown in FIG. 2. In a modular system, each block of the system can be tailored for one of a multiple set of operations. The system incorporates setup registers that control how the components operate. The registers are mapped as memory locations in a processor's I/O memory space and must be loaded before the system can be utilized. Therefore, the processors configure the system in accordance with a particular setup and individual blocks then function as they have been configured until a new configuration is loaded. In the following description, alternative configurations will be referred to. In each case, the alternatives refer to coordinated settings of the setup registers across the modules.

Camera 20 is similar to camera 10 and generates image signals that can be readily digitized or are already digitized. Camera 20 may have one or multiple taps, or may include multiple cameras each with one or multiple taps. Camera 20 is located close to the target (not shown) and the image output by the camera 20 depends on the mechanical relationship between camera 20 and the target. Sensor interface circuitry 22 is co-located with the camera 20. This circuitry converts the signals from the camera 20 to a high speed serial data stream that is sent to the modular image processing system (MIPS 25) via a sensor link 24. The sensor link 24 is preferably an optical data link which is not susceptible to noise and is capable of spanning sufficient distance to allow the MIPS system 25 and its host processors to be removed from the industrial environment proximate to the target.

A signal reception and processing unit 26 unpacks the conditioned image data from the link 24. In addition, it repacks the data onto a continuation serial link 24′ for use by other image processing components (not shown). The processing unit performs various registration tasks associated with converting the image as presented by the camera 20 into an image that represents the target 14. The signal reception and processing unit 26 is programmed and monitored by an embedded processor 30 and a host processor 32 via a processor bus 28. The embedded processor 30 and host processor 32 (not shown) are preferably from the same family of processors to simplify the operation of the processor bus 28. One of the prime uses of the processor bus 28 is to give the host processor access to an image memory 34 for display or post processing tasks.

Once the signal reception and processing module 26 has processed the image from the camera 20, it passes the image to an acquisition image memory (AIM) 34. While the data from the camera has been transported via a high speed serial link 24, the bus between the processing module 26 and the AIM 34 is a highly parallel interface 36 that allows writing multiple bytes of data simultaneously. A second highly parallel bus 40 moves the image data from the AIM 34 to a processing module 38.

The processing module 38 encompasses an array of parallel processors interconnected to perform the desired analysis of the image of the target 14. Before image processing begins, the processing array is configured to accomplish the analysis. The processing system 38 is connected to an embedded processor 48 and the host processor 32 by a processor bus 46. In many cases, part of the process of analyzing the target image involves comparing the image from AIM 34 with a template that is stored in a processing image memory (PIM) 44. The PIM 44 also holds intermediate results as they are developed for use in subsequent processing and final results of processing. The processing module 38 may also pass results to the host processor 22.

Each of the components in the system illustrated in FIG. 2 may be replicated in order to handle larger image data sets or to accomplish functions that require further processing power. Illustrations of this modularity are provided below. In the following description, the system is described as if there were one instance of each component.

The camera selection, placement and electrical set up determine a set of attributes for the image data associated with that camera, such as horizontal interleaved with a particular order of pixels. A master host processor maintains a database of these attributes and a set of context codes used by the sensor interface to associate the data with a set of attributes. The processor uses its knowledge of the data attributes to customize image data processing via the set-up registers. Therefore, image data stored in the AIM 34 is correctly manipulated. Context code attributes include: how many bits are used to represent a pixel; where this piece of the image should be stored in image memory (i.e. how it fits with the rest of the image); whether the pixels are being presented horizontally or vertically flipped; an interleave factor for the tap; the horizontal size of the image from this tap, and the vertical size of the image for the tap, if relevant. Separate elements of the MIPS 25 manipulate the data based on the context code as the pixels move toward the image memory.

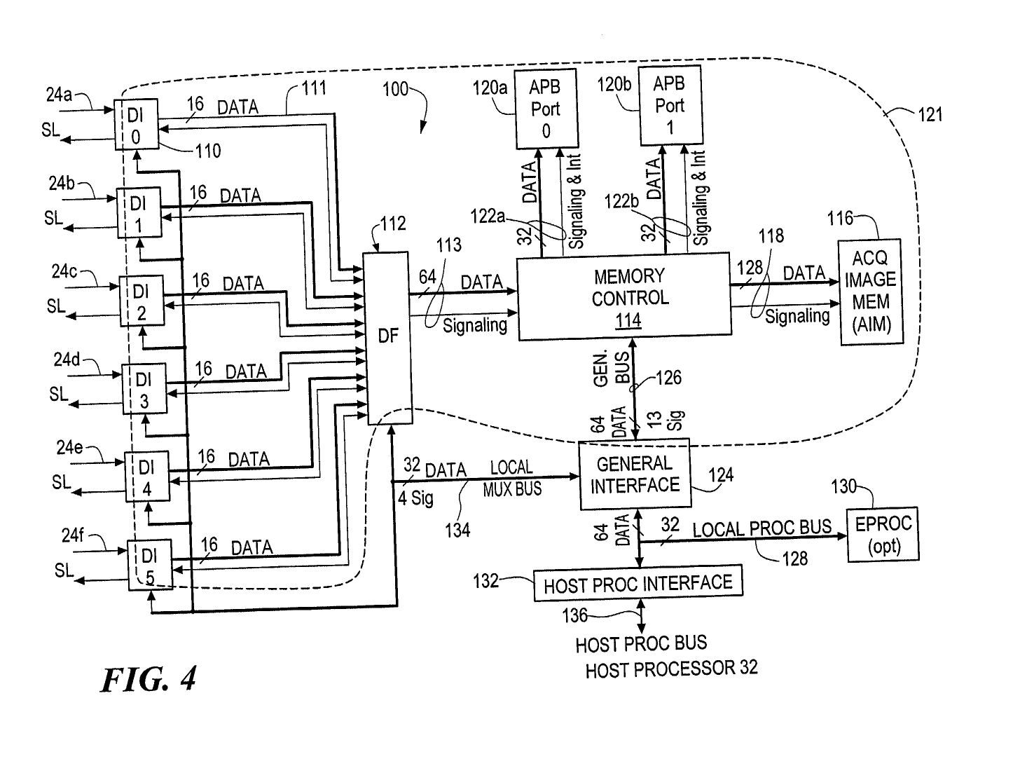

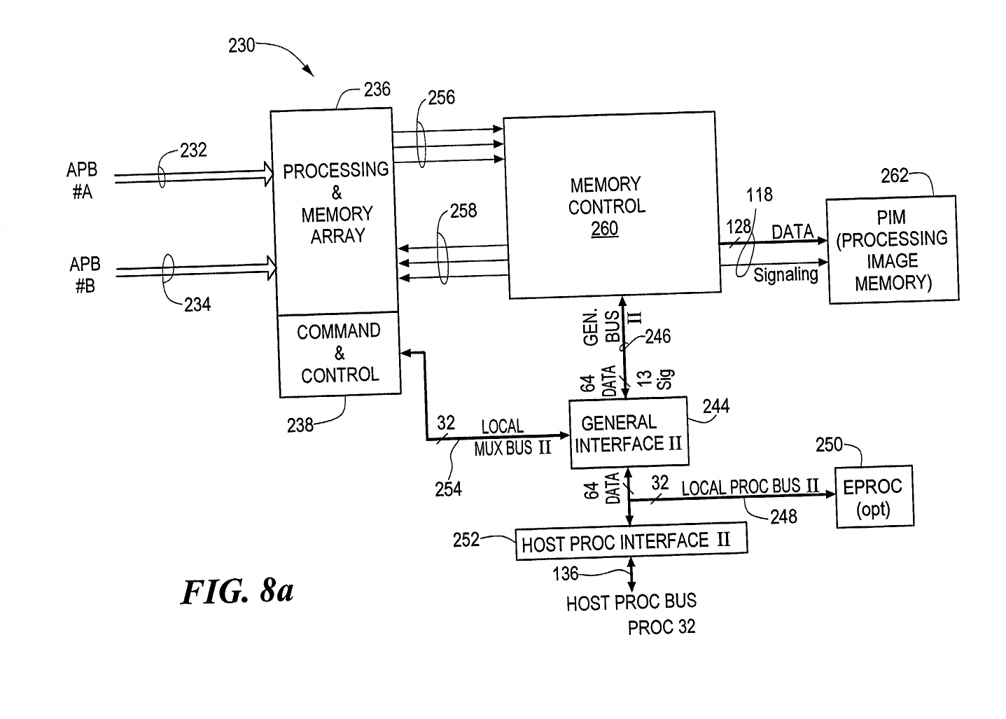

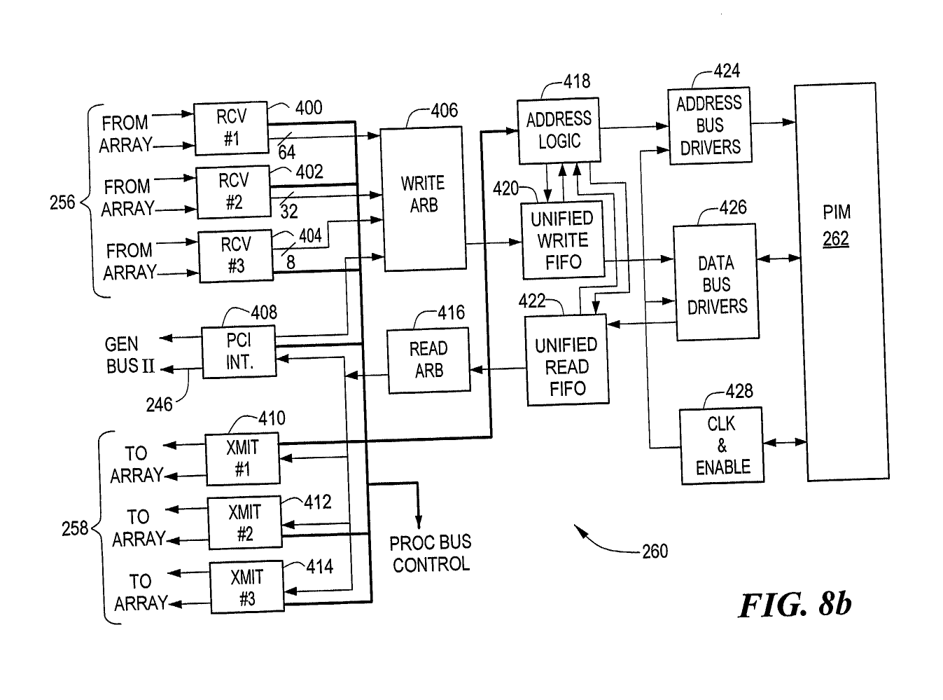

As shown in FIGS. 4 and 8a, each of boards has an interface to the processors that perform the same functions. The processors 32 and 130/250 send and receive data to/from logic on the acquisition board 100 and processor board 230 communicate via a bus. For an exemplary implementation, the host proc bus 136 and the local proc bus 128/248 are variations of the PCI Bus. The logic on the boards 100/230 presents too heavy a load for a traditional processor bus. Therefore, a general interface 124/244 buffers the processor busses 128/248 and 136 and performs some data bit width conversion. Either the host processor 32 or the embedded processor 124/244 can communicate with the acquisition image memory (AIM) 116 or processor image memory (PIM) 262 respectively and monitor and control the other components, through the general interface 124/244.

In the illustrated implementation, the host proc interface 132/252 is a bridge that isolates the local proc bus 128/248 and the host processor bus 136. The host proc interface 132/252 supports configurations with either a 32 or a 64 bit data path with throughputs that are selectable both on the host processor 32 side as well as the embedded processor 130/250 side. In addition, the host proc interface 132/252 performs any translation needed to allow the processors 32 and 130/250 to communicate over the local proc bus 128/248, including allowing the host processor 32 to download to the embedded processor 130/250. The local process bus 128/248 supports a 64-bit wide data bus, although in one implementation the embedded processors 130/250 use the local proc bus 128/248 as a 32-bit wide bus. The general interface 124/244/ utilizes the local proc bus 128/248 to send data, such as the contents of status registers, interrupt registers and image memory, to the processors 130/250 and 32 and to receive data for the DI's 110, DF 112 and array 236 from the processors 130/250 and 32. The set-up registers for the SI 22, DI 110, DF 112 and array 236 are mapped on the I/O memory space of the local proc bus 128/248. The general bus interface 124/244 sends data for the SI 22, DI 110, and DF 112 to those components over the local mux bus 134/254 and transfers data with the AIM image memories 116/262 utilizing the gen bus 126/246. The general interface 124/244 acts as a master on the local mux bus 134/254, and the DI's 110, DF 112 and array 236 act as slaves when receiving set up data or providing feedback data on command. The general interface 124/244 can act as master to the memory controllers 114/260 to send interrupt and control words. In addition, the general interface 124/244 supports direct memory access to import/export image data to/from the AIM 116 and PIM 262.

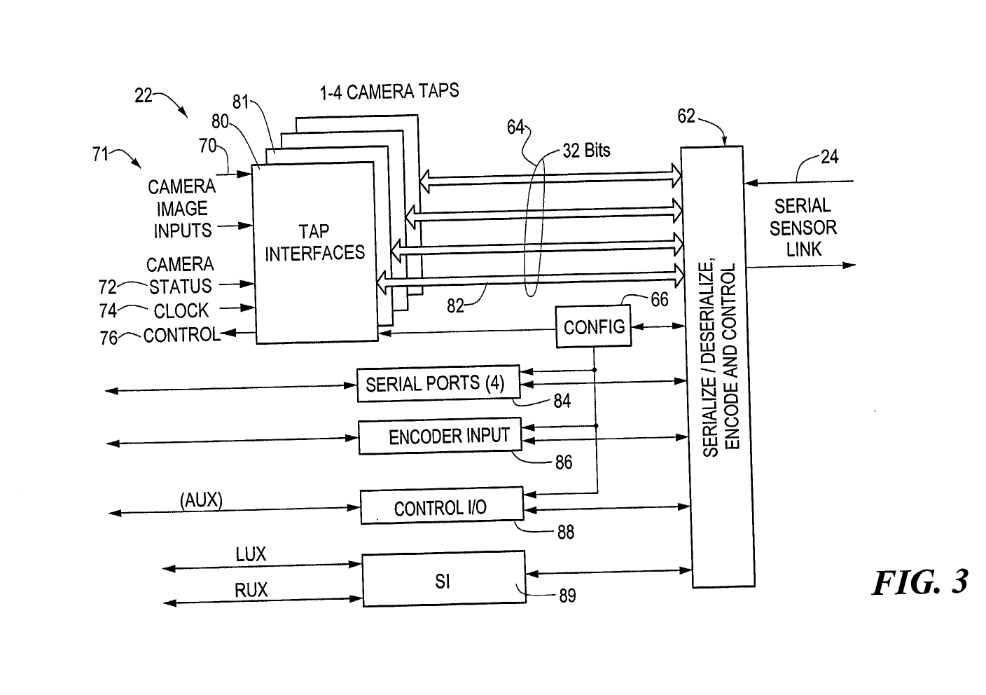

FIG. 3 is a block diagram of the sensor interface (SI) unit 22. The sensor interface 22 is located near the camera or cameras 20 providing image data to the system. It receives data from traditional electrical connections on the camera 71 including connections for image data 70, status 72, clock 74 and control 76. The SI 22 is customized to use the camera's signal levels on the inputs, and outputs data signals understood by the rest of the interface. A serializer/deserializer, (SERDES) in the serializer/deserializer, encoder and control logic block 62 converts the data into a serial stream, which is carried by the serial sensor link 24. The encoder (in 62) also extracts and/or inserts serial port data 84, encoder inputs 86 and control line data 88 from/into the serial sensor link 24. The control logic (in 62) controls the shutter and handles synchronization.

The sensor interface (SI) 22 is itself modular and may be customized for a particular camera connection by changing interfaces. As an example, the interface may receive low voltage digital signals or can receive differential signals. In addition, camera taps can be configured for the same or different data bit widths. The sensor interface card can be configured for multiple cameras, for multiple taps on a camera or for multiple components such as RGB from a single tap. Utilizing FPGAs makes reconfiguring for number of bits per tap economical. In one aspect, sensor interface cards supporting camera data rates from DC to 66 megahertz have been implemented. The different path widths into the SI 22 allow alternate configurations of the cameras to be utilized.

A serial connection 24, referred to as the sensor link (SL), connects the sensor interface 22 to the signal reception and processing block 26. Because the sensor interface 22 converts the high-speed parallel signals into serial signals, the sensor link 22 needs to be a very high-speed connection. In one aspect, the SL 24 is a fiber optic link with a data transfer rate of 100 MByte/sec and a control transfer rate of 25 MByte/sec. The bi-directional sensor link 24 terminates in the SI 22 at the serializer/deserializer, encoder and control logic block 62.

In the input direction, the serializer/deserializer 62 functions as a multiplexor merging the data and controls into the serial stream. Up to 4 independent taps or cameras 80, 81 connect to the serializer/deserializer 62. In one implementation the serializer/deserializer accepts data 64 in up to 32-bit words from up to 4 sensor taps 80, 81. In this configuration, when camera data 71 is 8 bits wide, 4 sensor taps 80 can be used, while when camera data 71 is 16 bits wide only 2 sensor taps are accommodated. Alternate words with this can be implemented but must still conform to the overall bandwidth limitation of the SL.

In addition to the camera image inputs 70, there are camera controls that may be received by the SI 22 if they are generated by the camera. The clock control 74 is an input from the camera system. It may be common to all data inputs, or it may be individualized to allow asynchronous cameras to input data to the system. Coordinated with the clock are three status inputs 72, horizontal and vertical active allow the MIPS 25 to know when valid data is being presented on the camera inputs 70 and a camera status that marks when the camera inputs are a black level.

The MIPS 25 system sends control outputs 76 to the camera. In particular, trigger and expose outputs that initiate data gathering from the camera may be sent. These controls may be generated based on other inputs such as the encoder input 86 described below. Other input and output data that may be multiplexed on the serial connection include: bi-directional serial ports 84, control input/outputs 88, and encoder inputs 86. The bi-directional serial ports 84 are regarded as communications ports by the embedded processor and may be used to send sequences of commands to the camera or positioning equipment associated with the imaging hardware. The control input/output 88 is a set of differential signals that carry serial data to be connected to a encoder or camera that uses differential signal format. The encoder input 86 is provided to enable the system to track movement of the target, for instance, a web under inspection. Data that may be derived from the encoded input includes rate of speed and direction of travel of the target and the trigger timer may be activated by this input.

A configuration ROM 66 is incorporated in the SI 22 to set parameters as needed for a configuration. The processors 30 and 32 may not change this ROM, although an identifier for the ROM may be read over the serial link so the configuration can be confirmed. The ROM is used to set, for instance, the data width and number of camera taps to be used on this SI 22, what control I/O is active, whether the serial lines are utilized and the interpretation of encoder inputs. The ROM 66 also controls utilization of the synchronization signals 89. An SI 22 that receives the main synchronization pulse on the encoder input 88, can pass the synchronization to SI's to the right and left of it (where right and left may be defined relative to the image being collected) based on the state of the ROM 66. While the prior discussion has described the SI 22 as composed of one board where custom integrated circuits (either ASIC or FPGA) personalize the board for the required interface configuration, all the functions of the SI 22 may be implemented as discrete interface cards or some other mechanism.

The serial link 24 is a loop that is implemented so that it “passes through” one or more stations, such as the acquisition boards 100 of FIG. 4, before returning to the sensor interface 22. The SL 24 can support one SI 22 and up to 15 Acquisition boards 100 in the loop. The SL 24 allows the SI 22 to be placed a significant distance from the rest of the MIPS 25 system. In one implementation, the maximum length of the SL loop is 200 meters. In an advantageous implementation, the SL 24 uses the Gigabit Ethernet (IEEE 802.3) physical layer. In addition to the 100 MByte/sec bandwidth available for data transport, SL 24 provides up to 25 MBytes/sec of control and read/write information. The SL 24 also carries up to 16 interrupt events that are received by all connected devices. Each interrupt carries its own tag for identification. If the encoder input on an SI 22 is active, the SI 22 will multiplex the encoder data on the SL 24. Any Acquisition board 100 connected to the SL 24 can receive the encoder input. As in other blocks of the MIPS 25, setup registers on the SI 22 and acquisition boards 100 are configured to personalize each SL 24.

A block diagram of the acquisition board 100 is illustrated in FIG. 4. The acquisition board 100 can connect to 6 serial links 24a-f from sensor interfaces 22. Each sensor link 24 is connected to a data interface (DI) 110 that converts the serial data to parallel data. The data from the data interface 110 is passed to a data formatter (DF) 112 where it is organized for storage in image memory. The memory control 114 receives data from the data formatter 112 and from the processors 130 and 32 to be stored in the Acquisition Image Memory (AIM) 116. The memory control 114 provides data from AIM 116 to the processors 130 and 32 and to two Acquisition/Processor Board (APB) ports 120a, 120b. The embedded processor 130 is optional. The local data bus 128 allows the acquisition board 100 to function with tasks shared by both processors or with only the host processor 32 performing all tasks. The embedded processor 130 and the host processor 32 can control and setup the data formatter 112 and the data interfaces 110 via a local MUX Bus 134 both before data is gathered as well as during data reception. Except for the processor busses, the logic on the acquisition board 121 uses timing derived from a single clock. Each of the blocks of the acquisition board 100 is further detailed below.

One acquisition board 100 can gather up to 600 megabytes per second of input data from the sensors. The data interface (DI) 110 is the connection point between the sensor link 24 and acquisition board 100. The DI 110 is responsible for transmit and receive functions between the cameras 20 and the MIPS 25. The DI 110 executes the sensor link protocol and performs some pixel processing such as normalization. Each of the data interfaces 110 supplies data to the data formatter 112 after a serial to parallel conversion. The data from the DI 110 can be formatted in narrow pixels 8, 10, 12 or 16 bits wide, or in packed pixels that can be 24, 30 or 36 bits wide.

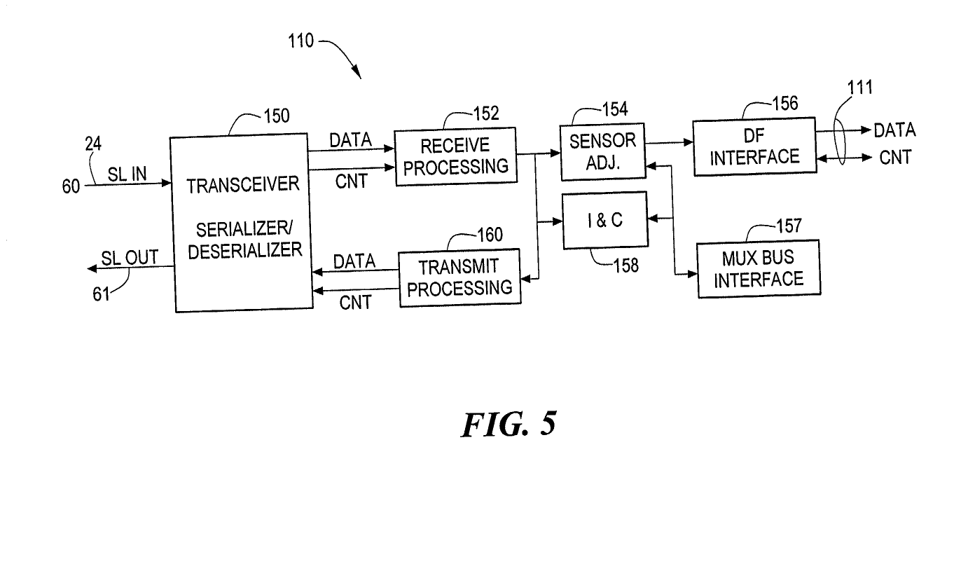

FIG. 5 is a block diagram of the data interface 110. The data interface 110 includes a sensor link interface 150, a receive processing chain 152, a transmit processing chain 160, a sensor adjustment function 154, an interrupt and control block 158, a mux bus interface 157 and a data formatter interface 156. The sensor link interface 150 provides a bi-directional interface between the sensor link 24 and the acquisition board 100. In the receive direction, it accepts a serial data stream 60 and converts it to a parallel stream along with the recovered clock. In the transmit direction, it converts a parallel data stream to a serial data stream 61. The interface 150 consists of a transceiver and a serializer/deserializer (SERDES). In one aspect the serial link is implemented utilizing fiber optics. In this case the transceiver provides a bi-directional optical to electrical interface. In the receive direction it accepts a fiber optic serial data stream and converts it to an electrical serial data stream. In the transmit direction, it converts an electrical serial data stream to a fiber optic serial data stream. In one aspect the sensor link further conforms to the low-level specifications of the IEEE 802.3 Gigabit Ethernet specification.

The SERDES within the sensor link interface 150 operates only in the electrical domain and in one implementation is fully compliant with the IEEE 802.3 standard. The receive side of the SERDES accepts the electrical serial bit stream, decodes the Gigabit Ethernet and converts the bit stream to a parallel data stream. As part of this operation, the SERDES recovers the clock signals that are embedded in the serial data stream, detects whether an input signal is present and decodes data according to the protocol being used. The transmit side of the SERDES accepts a parallel data stream, converts it to a serial bit stream and encodes it to conform to Gigabit Ethernet. In particular, the serial stream encodes a 10 bit parallel data stream allowing a data transmit speed of 125 MByte/sec.

The receive processing chain 152 receives the parallel data stream from the serial link interface 150 and processes it in the following sequence. It first handles all of the synchronization tasks such as finding the beginning of packets and maintaining synchronization with the data stream. Once the receive processing chain 152 identifies the boundaries of packets, it analyses the packets to detect and possibly correct any errors that are present in the packet. A packet that passes through the synchronization and error detection sequences is then classified. A received packet may be null or information bearing. Null packets serve to assure a reliable communications link. An information bearing packet may be one of three types: a interrupt and control packet that originated from this interface 110, a interrupt and control packet from another interface 110, or a data packet. An interrupt and control packet originated by this interface 110 has made a complete circuit and is discarded, removing it from the ring. A interrupt and control packet that originated at some other source is passed to the interrupt and control processing block 158 and additionally is passed to the transmit processing chain 160 so that it can continue on the ring. A sensor data packet includes image data. It is further processed by the receive processing chain 152 and is passed to the transmit processing chain 160 to be passed along the ring where it may be utilized by other parts of the MIPS 25.

The sensor data packet includes signaling bits (including context codes) that carry information needed to process the data within the data interface 110. This information includes framing signals that are used by the sensor adjustment block 154 and passed on to the data formatter 112. Further, if the context codes indicate that data was transmitted in a packed format, the data may be unpacked by the data interface 110.

The sensor adjustment block 154 is used when it is necessary to adjust the input from particular sensors before the data is placed in image memory. This block is used, for instance, when individual pixels on the sensors are known to have a different black level than the other pixels on the sensors. In this case, an adjustment is made to normalize the pixel's data to be compatible with the other pixels. The sensor adjustment block 154 is also used to normalize gains. In this case, one sensor may send image data using a higher precision than is necessary for the overall image. The sensor adjustment block 154 normalizes that data to the standard precision, thereby saving space in the image memory.

A look-up table (LUT) may be implemented in the sensor adjustment block 154. (Here, the table is used to provide adjustments for each pixel.) The adjustments could compensate for black level, gain, offset and non-linear factors present for the sensor.

The interrupt and control block 158 examines interrupt and control packets. There are two parts to the interrupt and control block 158: a receive part and a transmitter part. The receive part of the interrupt and control block handles control signals and interrupts from the sensor interface 22. If the interrupt and control block 158 determines that the data in the packet is directed to another DI 110, then no action is taken. If the interrupt and control block 158 determines that the packet is a control read, i.e. a response from the sensors to a previous request for data, then the interrupt and control block 158 determines whether the data in the control read packet is for this data interface 110. If the data is not for this interface 110, nothing is done. If the data is for this interface 110, the interrupt and control block 158 passes the data to a processor 130 or 32 through the mux bus interface 157. Data returned from the SI 22 can include parameters or other values. If the interrupt and control block 158 determines that a packet is an interrupt packet, the interrupt is passed on to the processor 130 or 32.

The transmit side of the interrupt and control block 158 receives commands from the mux bus 134 to be sent to the sensor interface 22, and reformats the command into the predetermined format that is used on the sensor link 24. Write commands are used to program the sensor interface 22 or request a control read that causes the SI 22 to transmit data back to the DI 110.

The transmit processing chain 160 handles packets originating from this interface 110 and packets received from other interfaces to be forwarded on the ring. In forwarding packets, the transmit processing chain 160 reformats the data and command packets that were previously processed by the receive processing chain 152. The transmit processing chain 160 formats the contents, codes the data as necessary and places the data into the packet before providing the packet to the SERDES in the interface 150. The transmit processing chain 160 receives the contents of new interrupt and control packets from the interrupt and control block 158, formats the packets and melds them into the data stream. The transmit processing chain 160 assures that a steady of stream of packets is provided to the SERDES by transmitting null packets when no data or interrupt and control packets are available from the other sources. Interrupt events do not wait for a particular type of packet, but are incorporated into the format of the next packet to be transmitted.

It should be clear from the description of the receive processing chain 152 and the transmit processing chain 160 that data received from a sensor input over the sensor link 24 may be used by a number of interfaces of the set of data interfaces 110. The sensor link is capable of daisy chaining through up to 15 data interfaces.

The interconnect 111 between each data interface 110 and the data formatter (DF) 112 (FIG. 4) is composed of data lines and control lines. The 16 data lines are configured to be one of: the packed data as received from the SL 24 with 1 byte of data and 1 byte of unused bits, 1 word of unpacked data representing 8, 10, 12 or 16 bit pixels, or data formatted by translating the data received from the sensor link 24 using a look-up table, or the gain and offset correction. The control lines in the interconnect 111 include one control sourced by the data formatter 112 used to clock data from the data interface 110 to the data formatter 112. The remaining control lines are sourced by the data interface 110 and include: context codes, start of frame and start of line indicators, and a valid data indicator. This set of control lines allows the DI/SL system to operate independent of the DF 112 timing, while allowing data to be exchanged between the DI 110 and DF 112.

The DF 112 is responsible for using the context codes transmitted with the data to select the operations to be performed in the DF. These operations can include: unpacking the pixels; interweaving pixels that have come from different taps of the same camera; cropping the image so that only the needed part of the target image is saved in memory; possibly horizontally flipping the data before it is stored; tracking the context of data coming from a camera; and generating memory words that are presented to the acquisition image memory (AIM) 116. In addition, the DF 112 controls timing for data delivery among all the components it connects to. The DF 112 is setup by instructions from either the embedded processor 130 or the host processor 136. Once the image data has been formatted, the data formatter 112 presents the image data to the memory controller 114 in 64 bit-wide words.

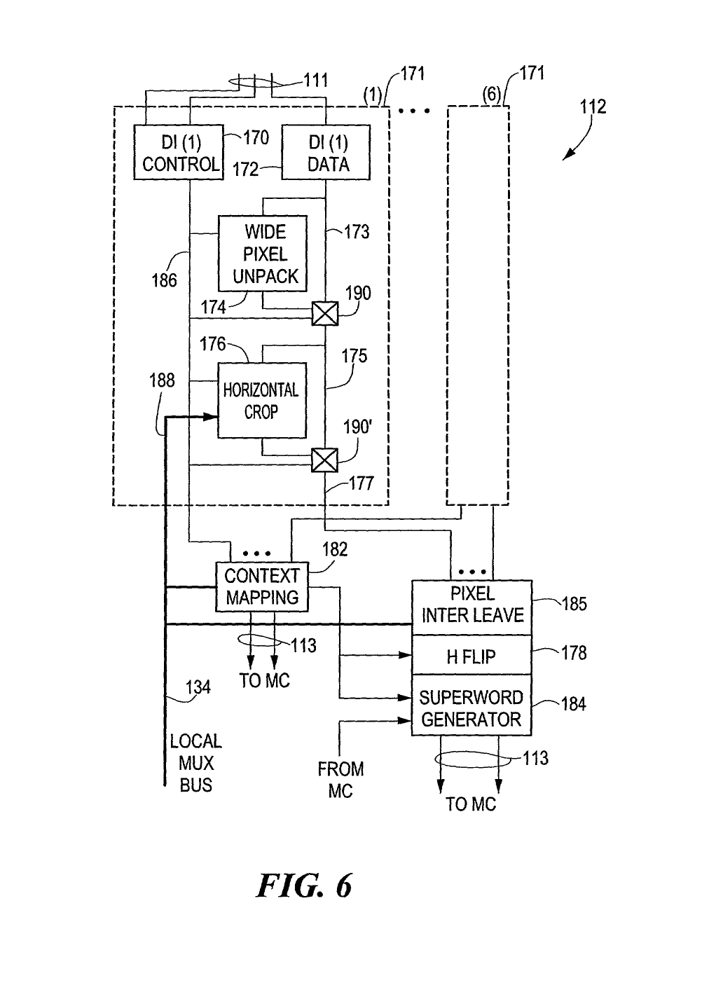

The data formatter (DF) 112, as shown in FIG. 6, consists of six data channels 111 each feeding a DI channel 171(shown as 171-1 thru 171-6). Each DI channel 171 includes the DI control receivers 170, DI data receivers 172, wide pixel unpack logic 174, horizontal crop logic 176, horizontal flip logic 178, and logic 190 at each stage to select either the manipulated data or data from the previous stage to pass forward. In addition to the channels 171, the DF 112 includes a processor interface 134 to receive the configuration data, a superword generator 184 that builds the word for the memory and a context mapping block 182 used to pass a compacted set of contexts to the memory control 114.

The context codes received through the DI control receivers 170 are matched against the set-up register to set the wide pixel and/or the horizontal cropping indicators (not shown). After the data has passed through the interface 172, it is unpacked by the wide pixel unpack logic 174. If the wide pixel indicator is set, then gating logic 190 allows the bytes from the wide pixel unpack logic 174 onto the data path 175. The bytes on data path 175 are fed to the horizontal crop logic. The horizontal crop logic 176 monitors the data path 175 and zeros out (crops from the image) specific words as dictated by the value loaded into the horizontal crop logic 176. If the horizontal crop indicator is set, then gate 190′ passed data from the horizontal crop logic 176 to data path 177, otherwise the data on data path 175 is passed through.

The DF 112 performs some of the configuration-dependent data manipulation that the context codes indicated were required. Therefore, as the data is passed from the DF 112 to the memory controller 114 less information needs to be carried by the context codes. The context mapping block 182 takes the 24 possible context codes originally sent by the SI 22 and transforms them into the 12 possible context codes sent to the memory controller 114.

The processors send synchronizing and setup commands over the local mux bus 134 to, for instance, set the boundaries of the crop regions, determine the context map, set the interleave factor and synchronize the acquisition time 180 to the start of a frame. When pixel interleaving is required across so many camera taps that all of the interleaving cannot be accomplished in the data interface 110, the pixel interleave logic 185 interleaves the pixels 185 after the pixels have been processed by the wide pixel unpack logic 174 and horizontal crop logic 176. The specifics of the interleave are determined by the values placed in the configuration registers (not shown) by the processors 130 and 32 If the horizontal flip indicator (not shown) is set, then the horizontal flip logic 178 flips the interleaved word, otherwise the interleaved word is passed directly to the superword generator 184. The superword, 128 bits, is the width of words in AIM 114. The superword generator 184 receives narrower words from the horizontal flip logic 178 and packs those words into 128 bit words. In one implementation, package pin count limits the ability to transfer superwords to the memory controller so superwords are broken into 64-bit big words for the transfer.

The bigword path 113 to the memory controller 114 is composed of the 64 data lines and a number of control lines. The control lines indicate the context code, identify which half of the superword is on the bigword data path, and identify which bytes of the bigword are valid. There are also indicators for the first pixel of a frame, the first pixel of a line, the end of a line and the end of a frame.

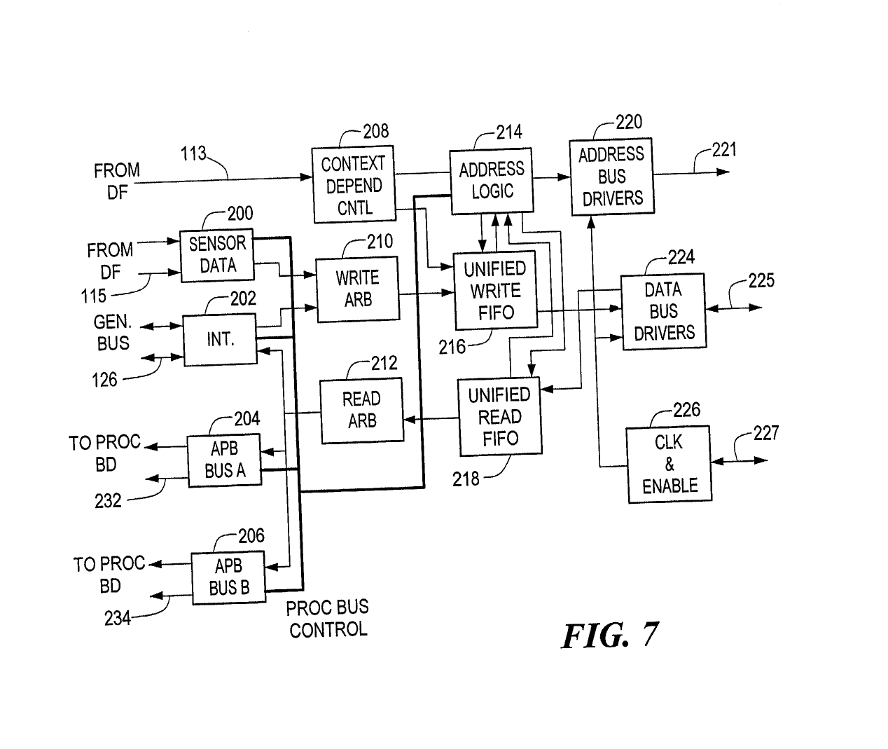

FIG. 7 illustrates the organization of the memory controller 114. The memory controller 114 receives data to be stored in memory 116 from two sources. Bigwords of sensor data 115 are received at the sensor data port 200, while the 12-state context information 113 about the data being transferred and other control signals are received in a context dependent control block 208. Data can also be written into the memory from the processors 32 and 130 over the general bus 126 received by the port 202. The incoming data is subjected to arbitration 210 before being written into a unified write FIFO buffer 216. The sensor data port 200, processor interface port 202, address logic block 214, and the two output ports 204 and 206 are each configured by the processors 32 and 130. The address logic 214, for instance, is configured to recognize which context code signifies that the horizontally flipped address sequence must be used while writing to the memory 116. The data bus drivers 224 write the data as 128-bit superwords to the memory and also drive control lines that specify which bytes of the superword are valid.

Data is delivered from the memory by the memory controller 114 to three ports. The data is read out of the memory through the bi-directional data bus drivers 224. The 128-bit superword is stored in a unified read FIFO buffer 218. Narrower words are fed out of the FIFO buffer 218 to the read ports, as determined by the read arbitration logic 212. The read side of the bi-directional interface 202 receives 32-bit words of image data. The two acquisition/processor board (APB) ports 204 and 206 accept 32-bit words of data to deliver to the processor board.

FIG. 8a is a block diagram of a processing board 230 implementing the processing block 38 of FIG. 2. The logic connecting this board to a host processor 32 and its bus 136 and an embedded processor (optional) 250 is equivalent to the acquisition board bus logic as previously described. The two APB busses 232 and 234 bring words of image data to a processing and memory array 236. This array is configured by either the embedded processor 250 or the host processor 32 using the local mux bus II 254 to write data to the command and control portion of the array 238. The processor(s) 32 and 250 also load significant data into a processor image memory (PIM) 262, especially master patterns against which the received image will be compared. The array 230 retrieves a master pattern from the PIM 262 via the receive ports 258. The receive ports 258 are composed of two 4-byte wide data paths and a 1-byte wide path. The array 230 stores results in the PIM 262 via transmit ports 256 that deliver data organized in the same manner as the receive ports 258.

FIG. 8b illustrates the organization of the processing memory controller 260. The processing memory controller 260 performs similar functions to the acquisition memory controller 114 of FIG. 7. It coordinates data flows between the PIM 262 and the other components on the processing board 230. Two sources can write to the PIM over four data paths. The array writes over a bus 256 that is broken into two 4-byte-wide inputs 400, 402 and a 1-byte-wide input 404. The processor(s) 32 and 250 access the PIM 262 through a port 408 to the memory controller 260 from general bus II 246. A write arbitration block 406 tracks the data and assures that the data is aligned in a unified write FIFO buffer 420 for bigword writing to the PIM 262.

The data read out of the PIM 262 can be distributed to one of two sources using four data paths. The array receives data over a bus 258 that is broken into a 1-byte-wide output data path 414 and two 4-byte wide outputs 410 and 412. The processor(s) 32 and 250 received data from the PIM 262 through the port 408 that connects to general bus II 246. The read arbitration block 416 breaks out the appropriate sized data for a port and assures that all valid parts of the full superword in the unified Read FIFO buffer 422 are distributed. The address logic 418, address bus drivers 424, data bus drivers 426 and clock and enable functions 428 perform as in the acquisition section described in connection with FIG. 7.

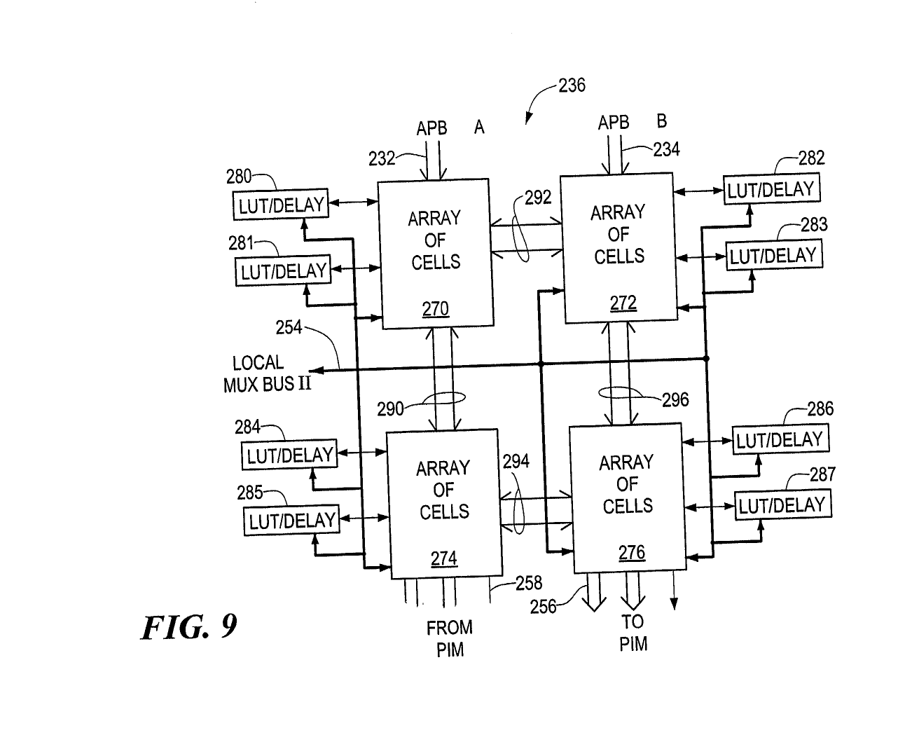

The primary processing functions are performed in processing and memory array 236 illustrated in FIG. 9. The processing is performed in programmable cell blocks 270-276, each of which can be software configured by the processors 32 and 250 via the local mux bus II 254 for a wide range of image processing functions such as convolution, morphology, look-up table (LUT), histogram and image arithmetic. Each configured block, for instance block 270, is a vector processor taking in image vectors from an external source (usually the AIM 116), processing them, and producing resultant scalars, arrays and output image vectors. The block 270 is a repeated array of smaller programmable vector image processors (cells) as described below. Each cell is configurably connected to adjacent cells and set-up for different vector image processing functions. The functions can include arithmetic functions and memory functions.

Associated with each block 270-276, are two block memories, for instance memories 280 and 281 associated with block 270. These memories can be read or written to by the associated block. They are well adapted for use as look-up-tables (LUT) and as delay lines. When operated as a delay line, the block memory stores data from one frame for use in processing a subsequent frame. The block memories 280-287 can also be loaded or read by the processors 32 and 250 via the local mux bus II 254.

Each of the blocks 270-276 can receive 32-bit data from the AIM 116 over one of the APB interconnects 232, 234. Interarray connections 290-296 allow the data to pass to any of the other blocks if so programmed. Similarly, the data to and from the PIM on busses 256 and 258 can be shared by the blocks 270-276 if so programmed. The programming of all these functions is accomplished by one of the processors 32 or 250 via the local mux bus II 254.

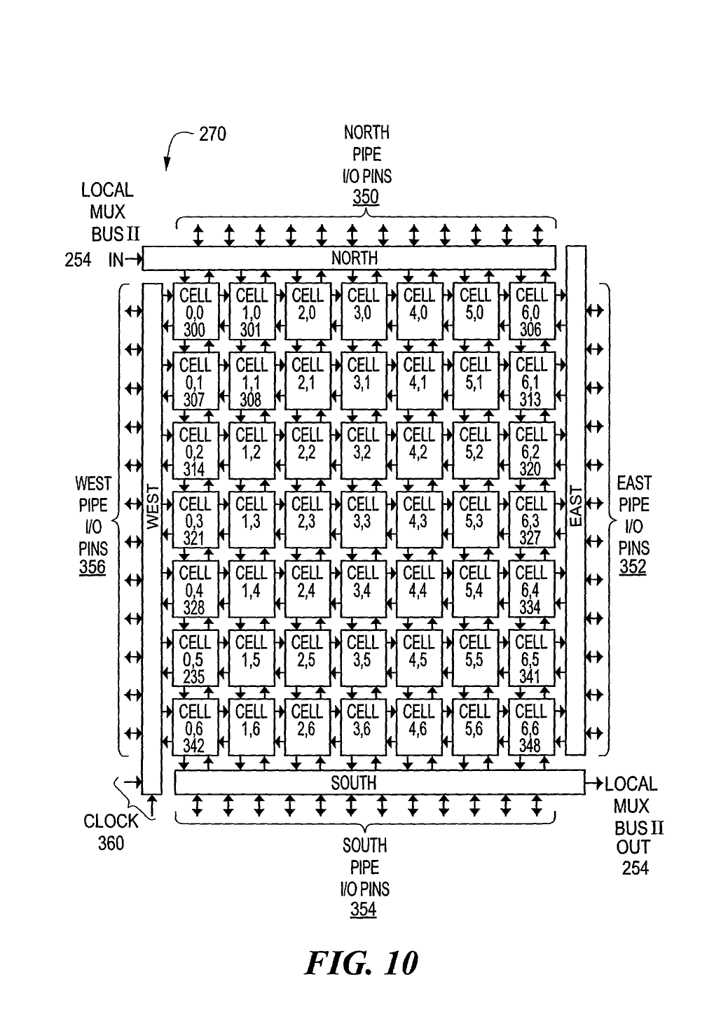

The organization of a block 270-276 is illustrated in FIG. 10. Block 270 is composed of 49 cells 300-348 arranged in a 7×7 array. Each side of each cell is connected to an adjacent cell or inter-block pipe. Hence, cell (0,0) 300 connects to the north inter-block pipe 350, the west inter-block pipe 356, cell (1,0) 301 and cell (0,1) 307. The processors 32 and 250 program each cell through local mux bus II 254 to activate the connections within the cell needed to accomplish the function to be realized at that cell. The clock signal 360 is the only signal that is routed to all cells all the time. Connections can be activated to pass a signal through a particular cell so that data flows through the block to the cell or pipe where it will be processed.

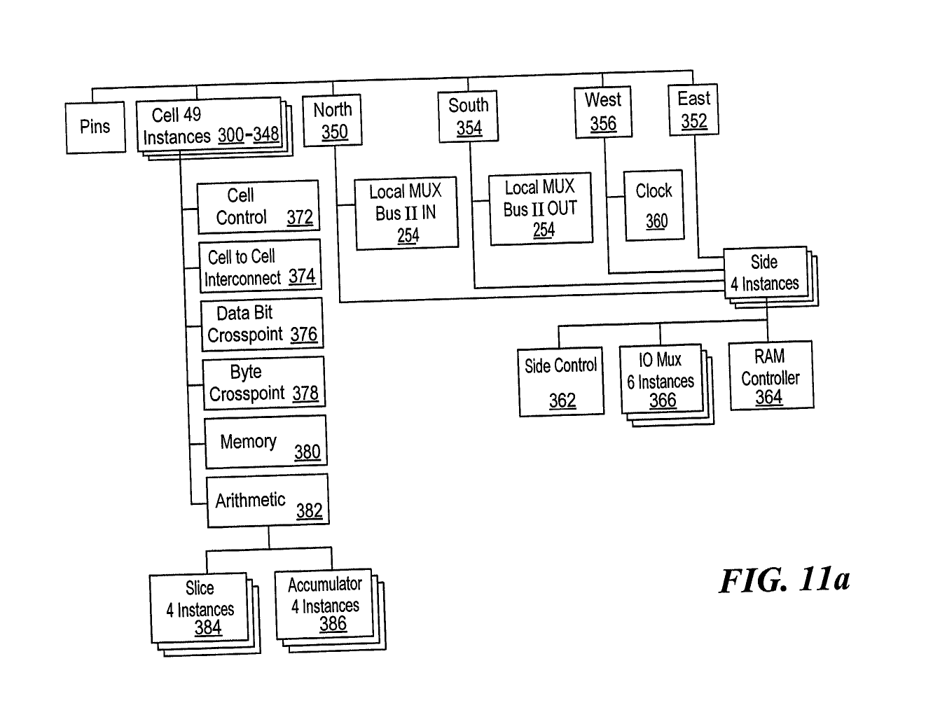

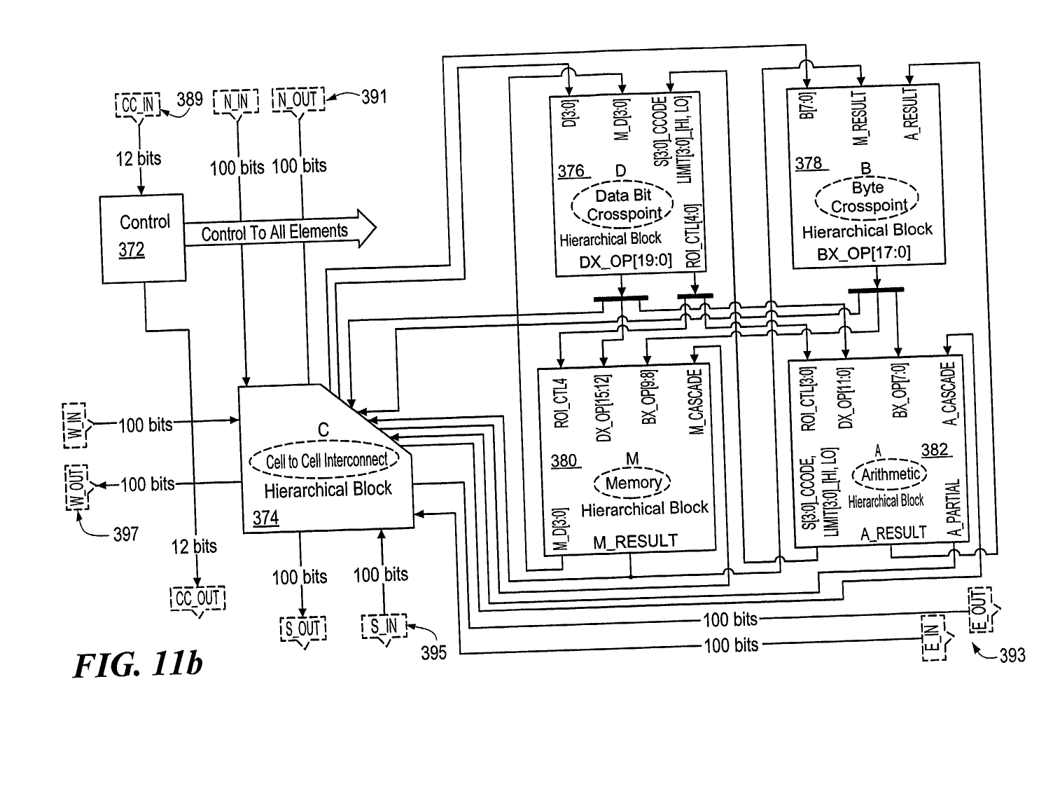

Each block 270-276 is organized as shown in FIG. 11a. The clock 360 and local mux bus II 254 can reach any cell through an edge 350-356. Controllers for the sides 362 and RAM memory 364 function block-wide as do the muxes 366 that implement the crosspoint switches for the sides of the block. Each of the cell instances 300-348 is composed of a cell control 372, a cell-to-cell interconnect 374, a data bit crosspoint 376, a byte crosspoint 378, a cell memory 380, an arithmetic unit 382, and four instances of each of a slice 384 and an accumulator 386.

In FIG. 11b, the cell structure is illustrated as an arithmetic function 382 and memory function 380 surrounded by a control block 372 and a set of crosspoints 376, 378 and 374 that deliver the arguments and results of operations performed in the cell. The control 372 sets up the data paths and operations. The crosspoints 376 and 378 assure that the bit and byte data are directed to the correct part of the cell. The cell-to-cell interconnect 374 allows data from other cells to be used internally, passes data through the cell and injects data generated in this cell into the proper data stream.

Algorithms to process the data are prepared in software that then translates the logical operations into set-up codes for the cells. This translation is accomplished using macros. The Macros provide for a selection of implementations programming the cells for processing speed or number of discrete resources used without changing the algorithms. The components of each cell can be programmably configured to provide at least one of: four 8-bit multipliers, four points of convolution using the summations and cascade logic for the multipliers, two 8×16 bit multiplications using 4 multipliers, one 16×16 bit multiplication using 4 multipliers, multi-banked constants for use as coefficients for the multipliers or as operands for the ALUs, short programmable delay lines for operand alignment, and shifters and clippers for data formatting.

In addition, the binary image can be routed, the ALU opcodes can be controlled and constants can be selected. The 8 bit ALU's can add, subtract, do logic, take minimums and maximums, average and bit count. Two ALUs can be used for 16 bit operations while four ALUs can be used for 32 bit operations. Feedback around the ALUs allows for accumulation and counting, while a gateway controller defines active data for statistics taking and processing.

The cell memory 380 is suited for histograms, statistics accumulation, operand alignment and LUTs. In particular, memory can be configured as one of: a 32K bit delay line sized as one of 32K×1 bit, 16K×2 bits, 8K×4 bits, 4K×8 bits, 2K×16 bits, 1K×32 bit, . . . ; a binary neighbor generator looking at—3×3, 5×5, or 8×4 pixels; a LUT using—12 bits in /8 bits out, 10 bits in/32 bits out, 15 bits in/ 1 bit out, . . . ; a histogrammer—of up to 10 bit data, 32 bit bins; bin accumulator with 512 bins, 32 bit data, 64 bit accumulation; and bin Min or Max, 4K bins, 8 bit data and results. The cell memory for multiple cells can be combined for larger functions

The 4 block array of FIG. 9 has the capability of up to 380 Billion operations (BOP)per second or 76 Billion Multiply-accumulates (MAC) per second per processor board at a 100 MHz pipeline processing rate. Each block 270-278 provides 95 BOP/sec or 19 Billion MAC/sec. Each block, composed of 49 cells, has chip to chip I/O of ˜4 GBytes/sec, broken into: ˜1 GBytes/sec for each inter-chip bus 290-298 (programming chooses direction, and bit width); ˜0.5 GBytes/sec between each chip and each LUT/delay; 0.8 GBytes/sec over the APB bus and 1.8 GBytes/sec between chips and PIM. By adjusting the bit width of the data paths, the effective pixel transfer rate can be adjusted with typical rates of 100, 200 and 400 Mpixel/sec being achieved.

The system's modular design allows incorporation of developing technologies. In particular, the processing board may be populated with fewer than the normal number of parallel-processing chips and, as more functional chips become available they can be incorporated. The image memory on both the acquisition and processing boards may be operated using higher capacity semiconductors, as they become available. Currently, the memory architecture is based on PC100 SDRAM,. This technology may be replaced by a commodity DRAM that is significantly faster such as the 100 MHz double data rate (DDR) SDRAM currently available. Such a substitution would increase the throughput of the MIPS 25. Similarly, as a serial protocol exhibiting a higher speed than the physical layer of the Gigabit Ethernet becomes available, a new implementation may integrate that higher speed link.

The MIPS 25 incorporates several scalability features to allow processing of different size images and images with different transfer rates. Sensor inputs 22 can be arranged so that varying groupings are possible. This allows high bandwidth data to be spread over multiple sensor inputs and multiple acquisition boards 100. In addition, sensor inputs 24 may be connected to multiple acquisition ports (DI 110), especially those on different acquisition boards 100, to facilitate computations that require the same data but are conducted on separate computation paths.

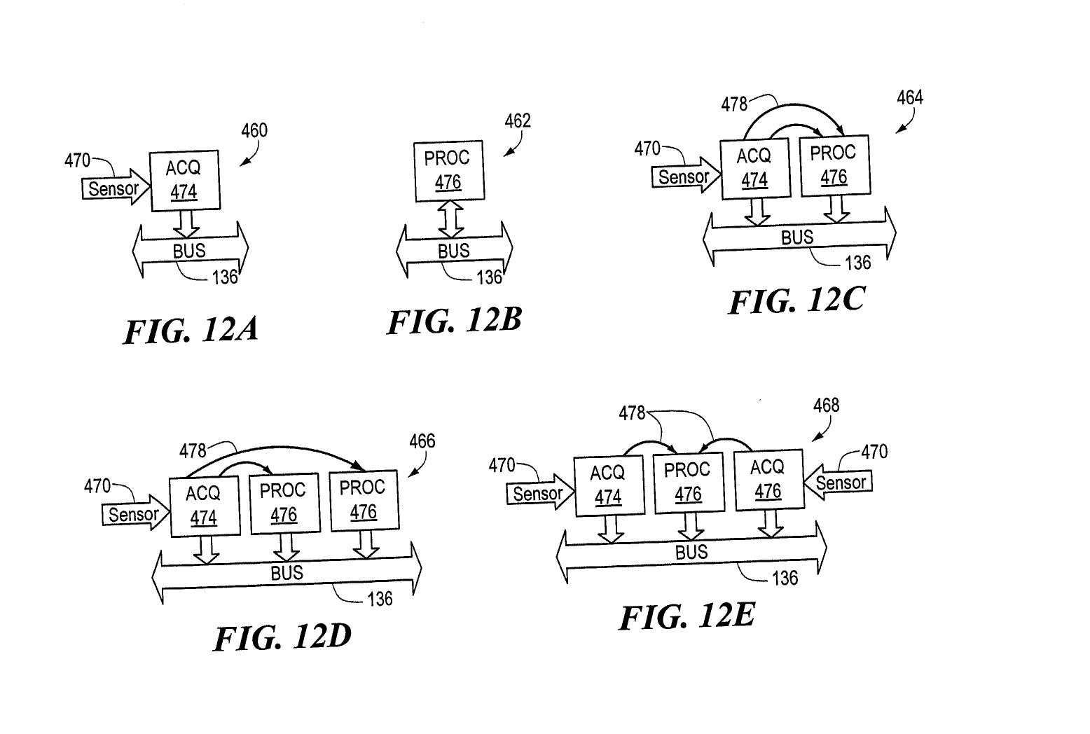

While one acquisition board 100 and one processing board may perform a complete image storage and analysis function, alternate configurations, as shown in FIG. 12, may be utilized with one host processor to accommodate different tasks. The configuration of FIG. 12A 460 allows sensors 470 to provide a representation of the image to be assembled in the acquisition board 474 image memory AIM. Processing of the image may be done by either the processing logic on the board or by the host that accesses the image via the host proc bus 136. The host processor does processing of those images after the image is transferred across the processor bus 136 to the host processor. The configuration of FIG. 12B 462 illustrates where the image must be fed to the array processor on the processing board 376 from the bus 136. The result of the array processing is returned to the host processor for interpretation and further action.

When the volume and speed of data and the computation task are approximately equal, the configuration of FIG. 12C is used. Here, the sensors 270 provide the representation of the image to the acquisition board 474 that uses both pipes of the APB bus 478 to feed the processing board 476. The processor bus 136 passes the results to the host processor, When computations to keep up with the data flow cannot be accomplished by a single set of pipeline processing cells, the configuration of FIG. 12D 466 is applicable. Here, the processing task is distributed between two processor boards 476. Once the data is assembled in the acquisition board 474, each pipe of APB 478 feeds a separate processing board 476 allowing computations to proceed in parallel on multiple processors. Alternately, the configuration of FIG. 12E 468 is used for extensive data sets that require only moderate processing power.

Each of the configurations of acquisition/processing boards of FIG. 12 can be replicated either within one host computer system or in multiple host computer systems. This allows for even more extensive data collection and processing. This level of scalability is facilitated by a software framework that makes coordination of multiple data computation paths a normal operation.

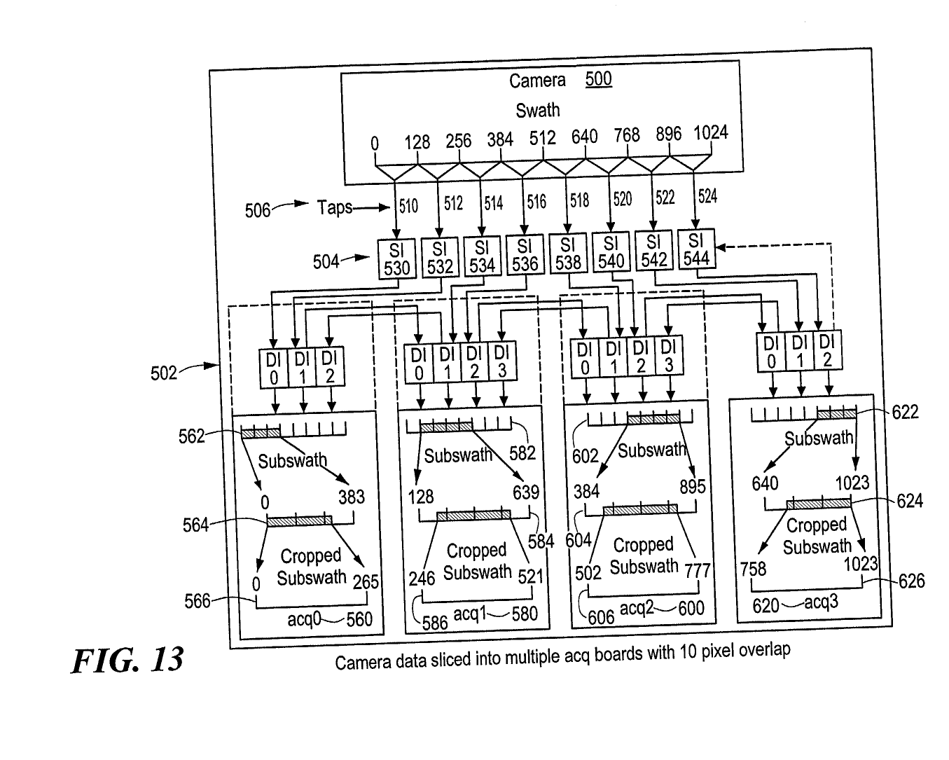

FIG. 13 is an illustration of a configuration that may result from an exemplary set of data acquisition requirements. In FIG. 13, one camera 500 is capturing an image of a target (not shown, but presumed for illustration purposes to be a line of image per unit time as the target passes beneath the camera) as 1024 pixels of data. The pixels may be an arbitrary number of bits deep. In order to output the pixels quickly enough to keep up with the moving target, the camera is set up with 8 taps 506, each outputting a stripe of 128 pixels. Each tap is connected to its own sensor interface/sensor link 530-544 that converts the pixel data into a serial bit stream. One of the sensor interfaces 504 also provides synchronizing signals, such as an encoder input, on the serial stream.

Analysis of the speed of the target and the density of pixels indicates that a swath of one quarter of the image can be written into an AIM memory in the time available. Therefore, four(4) acquisition boards 560, 580, 600 and 620 are needed to capture this image based on the data rate. Processing requirements could increase the number of boards needed, but the logic detailed below will still apply. In a particular case, the processing algorithm for each stripe needs 10 pixels beyond the boundaries of the stripes. Therefore, the first acquisition board 560 needs to store pixels 0-(255+10) or pixels 0-265, the second acquisition board needs to store pixels (256−10)-(511+10) or pixels 246-521 etc. To provide flexibility in configuring the acquisition process for varying tasks, the data streams carrying pixels are processed in two steps before being loaded into the AIMs. The actual pixels required for an acquisition board are designated “pixels of interest”. In the first step, SI's 504 sourcing any of the “pixels of interest” are connected to the data interfaces 502 for the appropriate acquisition board. This loose mapping of “pixels of interest” and data acquisition board allows the SI's to be configured based on the volume of data they can handle without regard for the acquisition and processing tasks. In the second step, the horizontal cropping registers 564, 584, 604 and 624 are loaded so the unneeded pixels are cropped off the data stream leaving only the “pixels of interest” to be stored in the AIM.

These two operations are illustrated in FIG. 13. Pixels 0-127 are sourced by their SI 530 to DI0 of the first acquisition board 560 where they form part of the subswath 562. No other swath needs these pixels, so they are not passed on to any other DI, such as acquisition board 580. Pixels 128-255 are sourced by SI 532 to the DI₁, of the first acquisition board 560 where they form part of the subswath 562. Pixels 246-255 are also need to for subswath 582, so pixels 128-255 are daisy-chained through DI₁, to DI₀ of the second acquisition board 580. Pixels 256-384 are sourced by SI 534 to the DI₁, of the second acquisition board 580 where they form part of the subswath 582. Since pixels 256-265 are also need to for subswath 562, pixels 256-383 are daisy-chained through DI₁, to DI₂ of the first acquisition board 560. Note that pixels 256-383 could have been sourced to DI₂ of acquisition board 560 and then daisy-chained to DI₁ of board 580 with equal effect. Subswath 262 now includes pixels 0-383. The connections to build up the other subswaths 582, 602 and 622 can be traced similarly. As the pixels pass through the previously configured DF 112 logic, pixels 266-383 are cropped from subswath 562 (see FIG. 6) by the cropping register 564 forming a cropped subswath 566. Only the cropped subswath pixels are stored in AIM 116. The AIM 116 on the first acquisition board 560 is loaded with lines of pixel data containing Pixels 0-265 from cropped subswath 566. The stored pixels are then available to be analyzed.

The system can accommodate acquisition and processing throughput in modular increments of 400 MBytes/second (maximum acquisition bandwidth of 600 MBytes/second per board). This provides multi-Gbytes/second throughput with multi-TeraOperations/second of processing power.

A system as versatile as the MIPS 25 system must be configured for its task. Some of that configuration happens at the time of planning an installation for imaging a particular target. This part of the configuration involves selecting a number of cameras, camera taps, sensor interfaces, sensor links and cropping factors as illustrated in FIG. 13. Part of the configuration is determined by the installation when the overlap of cameras is determined and the speed of operation is finalized. A further part of the configuration is determined by the processing required and therefore the way the processing array must be organized to handle the data. A master host computer must have access to all the configuration data to prepare the system for operation.

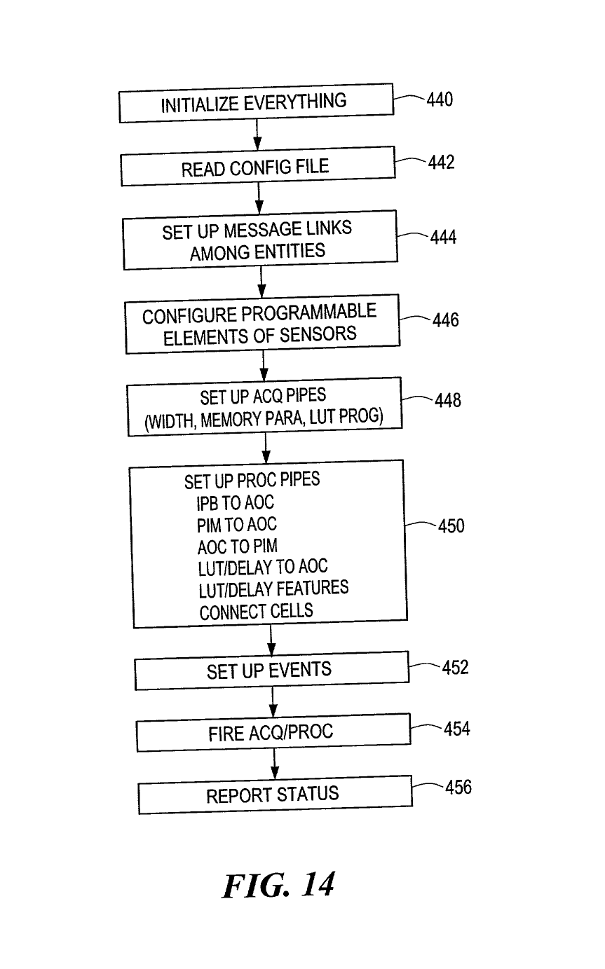

FIG. 14 is a flow diagram of the software that sets up the MIPS 25 system. This process must be performed each time the system is configured. At step 440, the system is initialized to flush extraneous data and reset variables like counters. At step 442, a configuration file to accomplish a task is read from storage and converted from readable form to sets of commands and parameters. If more than one host computer is utilized in the system, messaging links to coordinate processors and report status are established at step 444. The programmable aspects of the sensors are configured at step 446. This can include such activities as setting up interrupts from the encoder and using the serial lines to initialize the cameras. The Data Acquisition pipes are configured at step 448. This process includes specifying the width of useable data from each sensor link 24 for each acquisition board 100, specifying the starting point in image memory for the data that forms a context, setting the sensitivity adjustment for particular sensors, and enabling the flipping logic if the data arrives flipped. The processor data pipes and array are configured 450. This involves defining the connections between the data sources and the array of cells, filling the look-up-memories, setting timing features, loading the master patterns in the PIM 116 as well as programming the interconnection of cells to accomplish the processing. At step 452, the interrupt system is setup to control events to synchronize the system to the imaging target (e.g. a web). When the setup is complete, control is passed to a processing program 454 that starts the reception and processing of real time data. Concurrently with the processing program 454, a monitoring program 456 tracks status until the process is complete and the system needs to be setup for the next task.

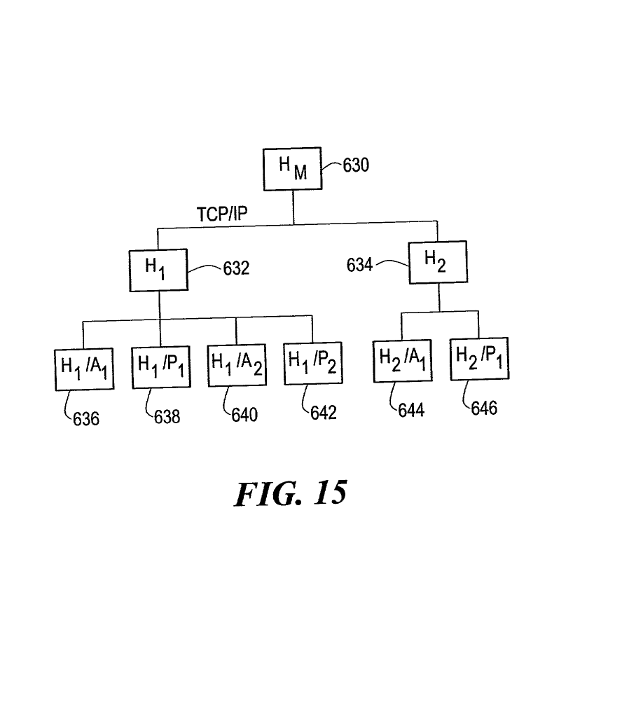

For large image processing tasks, a number of MIPS 25 and processors may be required. FIG. 15 illustrates a view of the processors in a system. A master host Hₘ 630 controls the entire system. It holds the primary databases and is responsible for operation of the system, pulling together and reporting the results of the processing. Hₘ 630 communicates, using a standard protocol such as TCP/IP, with other host computers H₁ 632 and H₂ 634 that house acquisition and processing boards for acquiring and processing image data. Each of the acquisition boards H₁/A₁ 636, H₁/A₂ 640, and H₂/A₁ 644 has an embedded processor that can be used to configure the boards as well as to field interrupts from the sensors. Each of the processor boards H₁/P₁ 638, H₁/P₂ 642, and H₂/P₂ 646 has an embedded processor also used to configure the boards as well as to process results from the parallel pipeline processing. The host processor H₁ receives intermediate results from the two MIPS 25 systems and normalizes and coordinates those inputs. The host processor Hₘ performs the coordination function for the entire system.

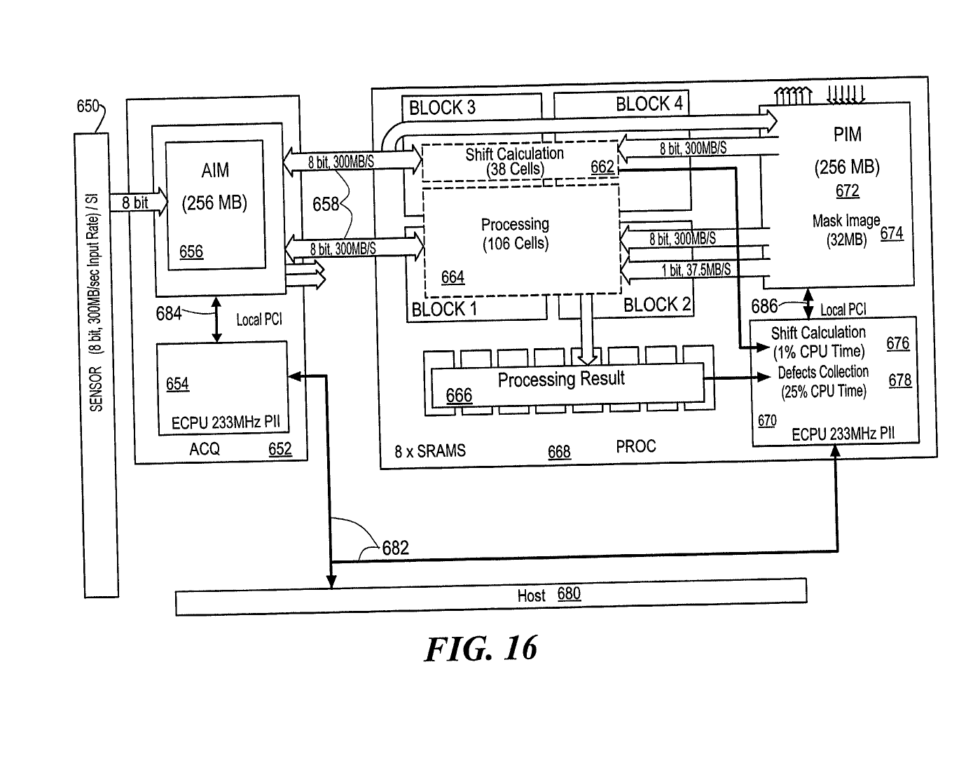

FIG. 16 shows a system suitable for low data rates and a modest processing task. Here, one sensor (camera) 650 feeds one acquisition board 652 and the data is processed by one processing board 668 with all of the components controlled by one host 680. The sensors generate 8 bit data at 300 Mbytes/sec that passes through the SI and SL(not shown) . Since only 256 MByte of AIM memory 656 is needed to hold the image data, the ACQ 652 is only populated to that extend. When only low-level processing is required of the local processor 654, a relatively slow processing chip can be installed. The data is transferred from AIM 656 to the PIM 672 and array processor 660 over the APBs 658. The array processor is configured to perform two operations—a shift calculation 662 that is fed to the local processor 670, and processing 664 that compares the mask image 674 to the incoming data. The result of the processing is stored in the memories 666 associated with the cell/arrays 660, from which it is fed to the local processor 670. The Proc local processor 670 is sized to handle the shift calculation 676 and defects collection 678 tasks with plenty of overhead for the local configuration tasks when needed. The host 680 communicates with the two local processors 654, 670 via bus 682 to provide set-up parameters and to collect results as needed.

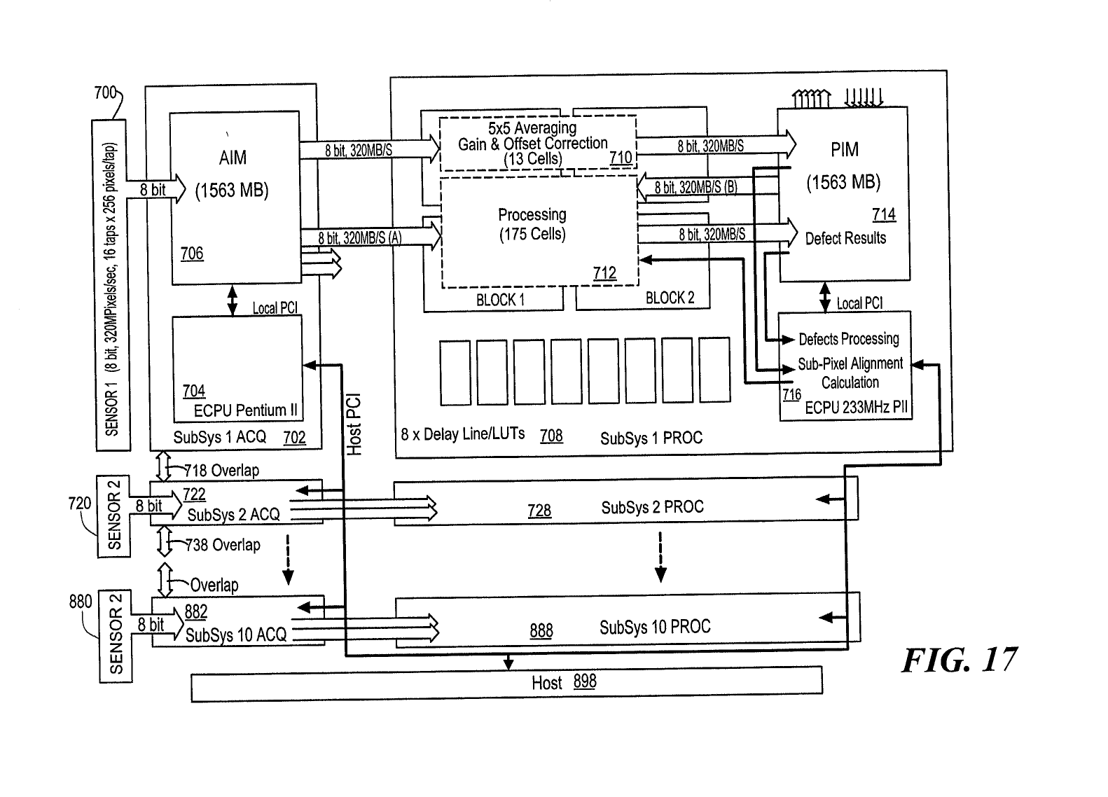

FIG. 17 shows a system suitable for larger image processing tasks. Ten sets of sensors 700 are needed provide data into ten sets of ACQ/PROC boards 702/708, 722/728 882/888 that process the data and pass results to one host processor 898. In this system, most components are configured to handle more speed or image data than the counterparts in FIG. 16. Each sensor, 700, 720 etc. supplies more data that is stored in the larger AIM 706, 726 etc. Each ACQ board 702, 722, etc. supplies this data to a PROC board 708, 728, etc, where the blocks process it, using the larger PIM 714, 724 etc to store patterns and intermediate results. The results generated by the PROC processors 716, 726, etc. are gathered by a host processor 898 to provide a final result. Note that the subsystems 702, 722, etc communicate via busses 718, 738 etc to allow an overlap of data for processing accuracy.

The software tools are provided as a hierarchical library that consists of four major integrated components:

1. Hierarchical Imaging and Control Library for top level full API interfacing,

2. Resource Manager to analyze the application functions and map each function onto the most efficient resource automatically,

3. Processing Concatenation providing automatic combining of multiple image processing and memory functions into single operations wherever possible and

4. Event and Data Flow Manager incorporating real-time data streaming management with interrupt and control logic.

With these tools, programmers have access to control every feature of the hardware to enable the best possible performance. However, because of the modular layered approach, the applications can be written with these tools to be transparently portable to other available architectures.

1. A modular image processing system comprising:
a sensor interface adapted to receive image data from at least one camera and transmit it;
an image capture and processing subsystem adapted to receive said transmitted image data, reformat said transmitted image data, store the reformatted image data in an image memory, and process said image data; and
a host processor adapted to provide mounting and power to said image capture and processing subsystem, programmably configure said sensor interface and image capture and processing subsystem, load image data into said image memory, read image data from said image memory, initiate processing of said image data by the image processing subsystem, analyze image data and process results of said processing subsystem.

2. The modular image processing system of claim 1 wherein said at least one camera has multiple taps.

3. The modular image processing system of claim 1 wherein said sensor interface provides image data at up to 100 Mbytes/sec.

4. The modular image processing system of claim 1 wherein said sensor interface is located proximate to said camera.

5. The modular image processing system of claim 1 wherein said sensor interface is adapted to receive differential input signals.

6. The modular image processing system of claim 1 wherein said sensor interface transmits image data on a serial link.

7. The modular image processing system of claim 6 wherein said serial link is an optical serial link.

8. The modular image processing system of claim 6 wherein said serial link has a bandwidth of up to 125 Mbytes/sec.

9. The modular image processing system of claim 1 wherein said sensor interface receives input from an encoder.

10. The modular image processing system of claim 9 wherein said sensor interface multiplexes said encoder input and said image data for transmission.

11. The modular image processing system of claim 6 wherein a serial link protocol allows bi-directional flow of control and status information between said sensor interface and image capture and processing subsystem.

12. The modular image processing system of claim 6 wherein said serial link is adapted for a daisy-chained connection through a number of receivers.

13. The modular image processing system of claim 1 wherein said reception of transmitted image data includes retrieving image data from a serial stream.

14. The modular image processing system of claim 12 wherein said reception of said transmitted image data includes retransmitting said image data.

15. The modular image processing system of claim 1 wherein said reformatting of said transmitted image data includes compensating for sensor inconsistencies.

16. The modular image processing system of claim 1 wherein said reformatting of said transmitted image data includes handling interleaving of pixels of image data.

17. The modular image processing system of claim 1 wherein said reformatting of said transmitted image data includes unpacking wide pixels.

18. The modular image processing system of claim 1 wherein said reformatting of said transmitted image data includes horizontal cropping.

19. The modular image processing system of claim 1 wherein said reformatting includes maintaining a context map of the image data.

20. The modular image processing system of claim 1 wherein said reformatting includes storing said image data to normalize for horizontal or vertical flipping.

21. The modular image processing system of claim 1 wherein processing the image data includes passing said image data through a processing cell array.

22. The modular image processing system of claim 1 wherein said image capture and processing subsystem includes an acquisition board and a processing board.

23. The modular image processing system of claim 1 wherein said image capture and processing subsystem includes a plurality of acquisition boards and a plurality of processing boards.

24. A method of processing real-time image data from multiple sources, said method comprising:
associating a context code with each source of image data;
delivering said image data and associated context codes to a data processing module, each image data being delivered in a format associated with said associated context code;
reformatting each image data by a process associated with its context code into a common format; and
storing each commonly formatted image data in a portion of an image memory as determined by interpreting its context code to form a unified image from said multiple sources in said image memory.

25. The method of claim 24 wherein said context code identifies the number of bits per pixel for said image data.

26. The method of claim 24 wherein said context code identifies a manner in which pixels are interleaved within said image data.

27. The method of claim 24 wherein said context code is associated with a starting address for storing said image data in said image memory.

28. The method of claim 24 wherein said context code identifies whether successive words of said image data are to be stored at successively higher addresses or successively lower addresses.

29. A method of handling a stream of image data representing the pixels of an image comprising:
feeding a different subswath of image data to each of a plurality of destinations, said different subswaths generally overlapping;
specifying to each of said plurality of destinations a unique portion of the subswath to be extracted from the subswath fed to that destination; and
storing said extracted portion of the subswath in an image memory for use in processing.

30. The method of claim 29 wherein said subswath represents a portion of the width of an image.

31. The method of claim 29 wherein each of said plurality of destinations is associated with a separate image capture system.

32. The method of claim 29 wherein said feeding comprises:
breaking said stream of image data representing the pixels of an image into a plurality of stripes of pixels;
connecting a stripe of pixels in a subswath to one of the plurality of destinations requiring those pixels; and
connecting the inputs of the plurality of destinations requiring said stripe of pixels in a daisy-chain manner.

33. The method of claim 32 wherein said daisy chain is an optical daisy chain.

34. The method of claim 29 wherein said specifying is implemented by loading a value into a register.

35. The method of claim 29 wherein said extracted portion of the subswath of image data is stored as lines of image data.
